(19) United States
(12) Patent Application Publication
(10) Pub. No.: US 2021/0263940 A1
(43) Pub. Date: Aug. 26, 2021

(54) INFORMATION PROVIDING SYSTEM

(71) Applicant: HONDA MOTOR CO., LTD., Tokyo (JP)

(72) Inventors: Tomoaki HAGIHARA, WAKO-SHI (JP); Satoshi KAMATANI, WAKO-SHI (JP); Mitsuki KIMURA, WAKO-SHI (JP); Yuiko KUMAGAI, WAKO-SHI (JP); Kazuya WATANABE, WAKO-SHI (JP)

(21) Appl. No.: 17/183,893

(22) Filed: Feb. 24, 2021

(30) Foreign Application Priority Data
Feb. 26, 2020 (JP) 2020-030276

(51) Int. Cl. G06F 16/2457; G06F 16/9537; G06F 16/9535

(52) U.S. Cl. CPC G06F 16/24578; G06F 16/9535; G06F 16/9537

(57) ABSTRACT

Referral text of first POI extracted by a POI extraction unit based on an input from a user is created using referral information associated with the first POI, and referral text of second POI extracted with a recommended priority lower than that of the first POI is created using, from among pieces of referral information associated with the second POI, the referral information of an item that differs from the item of the referral information used for the referral text of the first POI. It is possible to provide, to the user, the referral text created by taking into consideration a recommended priority, for the user, of a plurality of POI to be introduced to the user.

### CROSS-REFERENCE TO RELATED APPLICATION

This application is based upon and claims the benefit of priority from Japanese Patent Application No. 2020-030276 filed on Feb. 26, 2020, the contents of which are incorporated herein by reference.

### BACKGROUND OF THE INVENTION

### Field of the Invention

The present invention relates to an information providing system that provides information about points of interest (hereinafter referred to as POI or spots) to a user in accordance with a position of the user.

### Description of the Related Art

For example, in Japanese Laid-Open Patent Publication No. 10-013961 (hereinafter referred to as JPH10-013961A), a mobile communication system is disclosed in which, by a mobile terminal transmitting information of its own position to an information center, the mobile terminal is capable of using facility information or services of facilities related to position information which is stored in a storage unit of the information center (see paragraphs [0019] and [0119] of JPH10-013961A).

### SUMMARY OF THE INVENTION

The mobile communication system disclosed in JPH10-013961A provides the facility information and the like in accordance with the position of the user of the mobile terminal.

However, when a plurality of POI are introduced for one specific term, a problem arises in that no consideration is given to a recommended priority, for a user, of the plurality of POI to be introduced.

The present invention has been devised taking into consideration the aforementioned problem, and has the object of providing an information providing system, which is capable of providing, to a user, referral text created by taking into consideration a recommended priority, for the user, of a plurality of POI to be introduced to the user.

One aspect of the present invention is characterized by an information providing system comprising a points of interest (POI) information recording unit configured to record identification information of POI in association with referral information of the POI, and a referral text creation unit configured to create referral text concerning the POI by using the referral information associated with the POI, the information providing system further comprising a POI extraction unit configured to extract, based on an input from a user, a plurality of the POI to be output to the user, from the POI information recording unit together with a recommended priority, wherein the POI information recording unit records the referral information of the POI together with an item, and the referral text creation unit creates referral text of first POI extracted by the POI extraction unit, by using the referral information associated with the first POI, and creates referral text of second POI extracted with the recommended priority lower than the recommended priority of the first POI, by using, from among pieces of the referral information associated with the second POI, the referral information of an item that differs from an item of the referral information used for the referral text of the first POI.

According to the present invention, when referral text of a plurality of POI is created based on an input from the user, the referral text of first POI extracted by the POI extraction unit based on an input from the user is created using referral information associated with the first POI, and referral text of second POI extracted with a recommended priority lower than that of the first POI, is created by using, from among pieces of referral information associated with the second POI, the referral information of an item that differs from the item of the referral information used for the referral text of the first POI. Therefore, the referral text of the plurality of POI can be made in a diverse manner, and it is possible to increase the possibility that POI preferred by the user based on the input from the user can be quickly determined at one time. As a result, it is possible to provide, to the user, the referral text created by taking into consideration a recommended priority, for the user, of a plurality of POI to be introduced to the user.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram showing the configuration of a system including a server which serves as an information providing system according to an embodiment of the present invention;

FIG. 2 is a table in which there is shown an example of the content recorded in a POI information recording unit;

FIG. 3 is a tree diagram in which there is shown an example of the content recorded in a term recording unit;

FIG. 4 is a table in which there is shown an example of the content recorded in a user profile information recording unit; and

FIG. 5 is a flowchart provided to describe operations of the system including the server serving as the information providing system according to the embodiment.

### DETAILED DESCRIPTION OF THE PREFERRED EMBODIMENTS

An embodiment of an information providing system according to the present invention will be presented and described in detail below with reference to the accompanying drawings.

### Embodiment

### [Configuration]

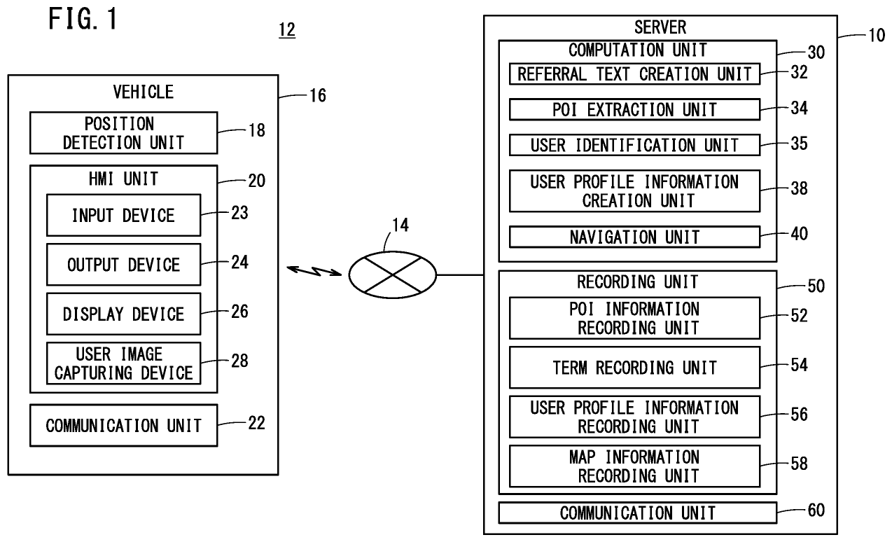

FIG. 1 is a diagram showing the configuration of a system 12 including a server 10 serving as an information providing system according to the embodiment.

In addition to the server 10, the system 12 is equipped with a vehicle 16 which is used by a user and which carries out communications via a network 14 such as a public line or the like.

The vehicle 16 includes a position detection unit 18, a human-machine interface unit (HMI unit) 20 that governs or controls an interface with the user, and a communication unit 22.

The HMI unit 20 includes an input device (a voice input device or a manual input device) 23 such as a microphone or a touch panel or the like, an output device 24 such as a speaker, a display device 26 that can serve in a dual manner as an input/output device, and a user image capturing device 28 which is made up of cameras.

The user image capturing device 28, for example, is a plurality of user monitor cameras which are mounted in the vehicle compartment interior, and which constantly capture images of all of the occupants in the vehicle by the plurality of cameras, including the head (face) of a user such as the driver. The user image capturing device 28 creates user captured image information of all of the vehicle occupants.

The position detection unit 18, for example, is a navigation device, and detects the position of the vehicle 16. As is well known, on the basis of recorded map information, the navigation device searches by way of a route searching unit for a recommended route to a destination set by the HMI unit 20 in accordance with an input from the user, and guides the user to the destination by guiding the vehicle 16 to the destination according to the recommended route that was searched for.

The communication unit 22 transmits to the server 10 via the network 14 the position information of the vehicle 16 that is detected by the position detection unit 18, the input information obtained by the input device 23 of the HMI unit 20, and the user captured image information obtained by the user image capturing device 28. Further, the communication unit 22 receives the information transmitted from the server 10, for example, route information to a specified POI, and outputs the information to the output device 24 or on the display device 26 of the HMI unit 20.

Moreover, according to the present embodiment, a navigation unit 40 of the server 10 obtains, through the communication unit 22, the network 14, and a communication unit 60, the destination that was set by the HMI unit 20 in accordance with the input from the user, searches for the recommended route to the destination (including the specified POI) based on the map information recorded in a map information recording unit 58, and sets the set route, which is the result of the route search, in the position detection unit 18 of the vehicle 16 through the communication unit 60, the network 14, and the communication unit 22. In this case, the vehicle 16 in which the user is riding is guided in accordance with the set route that is the result of the route search, and the user can be guided to the destination, or stated otherwise, route guidance can be performed.

The server 10 is a computer, and includes a computation unit 30, a recording unit 50, and the communication unit 60.

The computation unit 30 is constituted by a processor equipped with, for example, a CPU or the like. The computation unit 30 realizes various functions by executing programs recorded in the recording unit 50. In this instance, the computation unit 30 functions as a referral text creation unit 32, a POI extraction unit 34, a user identification unit 35, a user profile information creation unit 38, and the navigation unit 40.

In addition to the programs, the recording unit 50 includes a POI information recording unit 52, a term recording unit 54, a user profile information recording unit 56, and the map information recording unit 58.

The POI information recording unit 52 records the POI identification information and the POI referral information in association with each other.

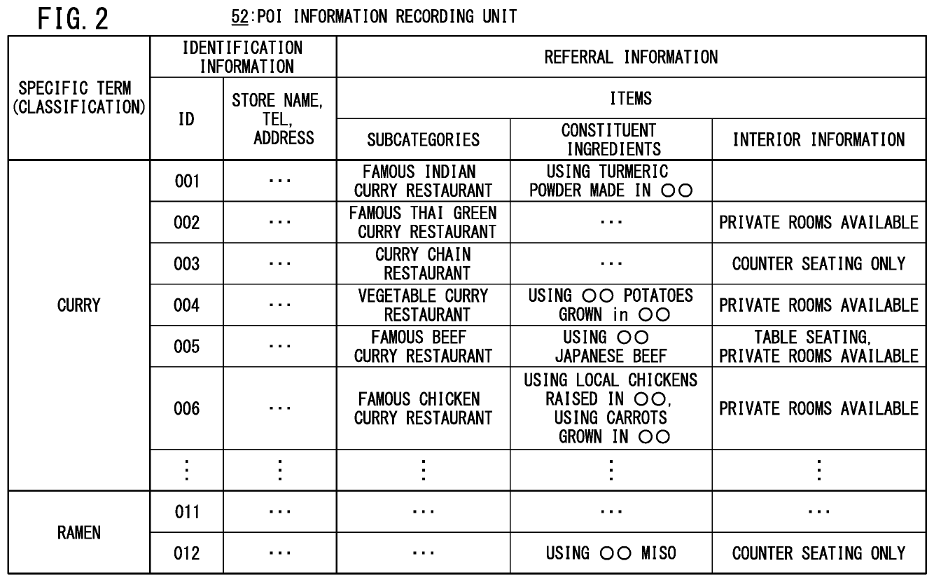

FIG. 2 is a table in which there is shown an example of the content recorded in the POI information recording unit 52.

The POI information recording unit 52 includes specific terms {classifications (curry, ramen, etc.)}, identification information {an ID, a store name, a telephone number (TEL), an address}, and referral information {items (categories, constituent ingredients, interior information)}.

The term recording unit 54 stores the specific terms and related terms (subcategories, constituent ingredients) having a predetermined logical relationship (in the present example, a systematic tree structure) with the specific terms.

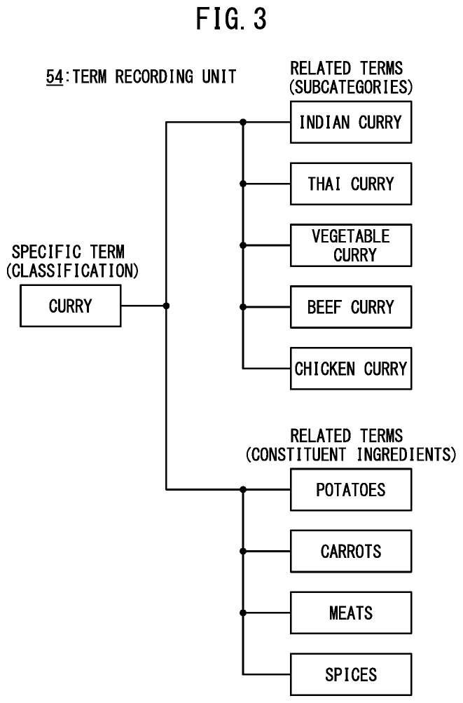

FIG. 3 is a tree diagram in which there is shown an example of the content recorded in the term recording unit 54.

The recorded content of the term recording unit 54 is made up from the specific terms (classifications, for example, curry) and the related terms (subcategories, constituent ingredients) having a predetermined logical relationship with the specific terms.

Among the related terms, the subcategories are Indian curry, Thai curry, etc., and among the related terms, the constituent ingredients thereof are potatoes, carrots, meats, spices, etc.

The user profile information creation unit 38 extracts a user profile based on user-specific behaviors (behavior history) of the vehicle 16, which are identified by the user identification unit 35, creates user profile (user-specific profile) information, and records the user profile information in the user profile information recording unit 56.

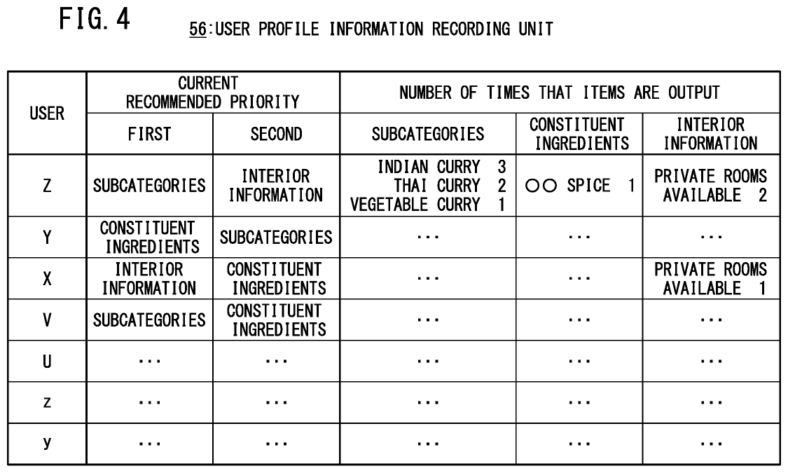

FIG. 4 is a table in which there is shown an example of the content recorded in the user profile information recording unit 56.

In the user profile information recording unit 56, current recommended priorities are updated and recorded for each of the users (Z, Y, X, V, U, z, y, . . . ) who are identified by facial images or the like. For example, for the user Z, a current first recommended priority is set within the subcategories (Indian curry 3), and a current second recommended priority is set within the interior information (private rooms are available 2). It is also possible for third and subsequent recommended priorities to be set.

The recommended priorities are set by a moving average, for example, every two months (capable of being arbitrarily set), of the number of outputs (in order of cumulative values) of items (subcategories, constituent ingredients, and interior information) that have been set in the past based on inputs from the user.

In the example shown in FIG. 4, as the number of outputs of items concerning the user Z, the number of outputs of subcategories is recorded three times for Indian curry, two times for Thai curry, and one time for vegetable curry. In addition, ◯◯ spice is recorded one time as a constituent ingredient. Furthermore, availability of private rooms is recorded two times as interior information.

Therefore, the current first recommended priority is set to subcategories (because Indian curry is recorded three times over two months), and the second recommended priority is set to interior information (because availability of private rooms is recorded two times over two months).

Moreover, in the example of FIG. 4, although the recommended priority of the POI is determined using information (subcategories, constituent ingredients, interior information) which are managed in the form of items of referral information, it is not essential that the recommended priority be determined in this manner. For example, the recommended priority for each of the POI may be determined from information other than information which are managed as items of referral information, for example, a price range or a distance from the position of the user.

The map information recording unit 58 includes route calculation information used by the navigation unit 40 to calculate the set route (recommended route), and route guidance information, road information representing the shapes of roads, and furthermore, background information representing map shapes other than roads, such as coastlines, rivers, railways, and buildings, etc., along with the POI information and the like, which are used for guiding the user's own vehicle 16 to a destination according to the recommended route including the names of intersections, road names, and the like.

The referral text creation unit 32 creates the referral text concerning specific POI.

The POI extraction unit 34 extracts, from the POI information recording unit 52, at least one of the POI to be recommended to the user, in accordance with the specific term (classification) that was set based on the input from the user of the vehicle 16. For example, the POI extraction unit 34 extracts the ID of the POI whose distance from the current location of the user lies within a predetermined distance of X km.

### [Operations]

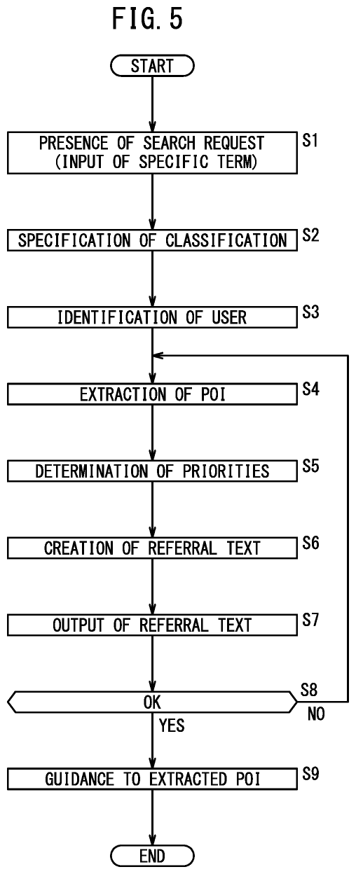

Next, on the basis of the flowchart shown in FIG. 5, a description will be given in detail concerning operations of the system 12 including the server 10 in the form of the information providing system according to the embodiment, which is configured basically in the manner described above. Unless otherwise specified, it will be assumed that the computation unit 30 of the server 10 executes the processes according to the flowchart. However, since it is complicated to refer to this feature each time that it happens, such a feature will be referred to only as necessary.

In step S1, the POI extraction unit 34 performs a specific term specifying process in step S2, which is triggered by the fact that a search request from the user Z that was input by the input device 23 of the vehicle 16 (in this instance, a search request made by voice, saying “search for a curry restaurant”) is received by the communication unit 60 via the communication unit 22.

In step S2, based on the voice input of “search for a curry restaurant,” the POI extraction unit 34 specifies the specific term (classification) as “curry” by referring to the specific term (classification) in the POI information recording unit 52 (see FIG. 2).

Next, in step S3, the user identification unit 35 compares the image (face image) captured by the user image capturing device 28 with face images recorded in the user profile information recording unit (user-specific preferences recording unit) 56, and thereby identifies the user Z. The user Z can also be identified by way of voice recognition.

In step S4, based on the specific term “curry”, the POI extraction unit 34 extracts, from the POI information recording unit 52 (see FIG. 2), the IDs of POI whose distance from the current location of the user lies within a predetermined distance of X km, from among the POI classified as curry. In this instance, it is assumed that the POI of ID 001 and the POI of ID 002 are extracted.

In the case that there are a plurality of POI extracted by the POI extraction unit 34, a recommended priority of the POI is determined in step S5. More specifically, based on the addresses of the respective POI recorded in the POI information recording unit 52, the recommended priorities of the POI are determined as a first priority (first recommended priority), a second priority (second recommended priority), . . . , in ascending order of distance from the current location of the user. In this instance, the POI of ID 001 is closer to the user's current location than the POI of ID 002, and the POI of ID 001 is determined to be the first priority, whereas the POI of ID 002 is determined to be the second priority.

Next, in step S6, the referral text creation unit 32 creates the referral text using the referral information recorded in the POI information recording unit 52 concerning the extracted POI (ID 001). More specifically, concerning the POI of ID 001, the referral text of the POI of ID 001 is created using one or a plurality from among the text “a famous Indian curry restaurant” for which the item of the referral information is classified as “subcategories,” and the text “using turmeric powder made in ◯◯” for which the item of the referral information is classified as “constituent ingredients.” From the fact that the referral information “famous Indian curry restaurant” is referral information including the related term “Indian curry” of the specific term that was set based on the input, and the referral information “using turmeric powder made in ◯◯” is referral information that does not include the related terms of the specific term that was set based on the input, the referral text creation unit 32 may make use of only the referral information “famous Indian curry restaurant” in the referral text, and not make use of the referral information “using turmeric powder made in ◯◯” in the referral text. Consequently, since the referral text can be created using the referral information including the related terms of the specific term, the referral text can be created while reducing any feeling of strangeness imparted to the user.

The referral text creation unit 32 creates the referral text using the referral information recorded in the POI information recording unit 52 concerning the extracted POI (ID 002). In this instance, concerning the POI of ID 002, the text “a famous Thai green curry restaurant” for which the item of the referral information is classified as “subcategories,” and the text “private rooms are available” for which the item of the referral information is classified as “interior information” are recorded as the referral information (see FIG. 2).

In this instance, the referral text creation unit 32 creates the referral text of a target POI, using the referral information of an item that differs from the item of the referral information used for the POI (ID 001) of the higher recommended priority.

More specifically, regarding the POI of ID 001, in the case that the referral text of the POI of ID 001 is created using both the text “famous Indian curry restaurant” for which the item of the referral information is classified as “subcategories” and the text “using turmeric powder made in ◯◯” for which the item of the referral information is classified as “constituent ingredients,” the referral text creation unit 32 creates the referral text of the POI of ID 002 using the text “private rooms are available,” which is the referral information of an item (interior information) that is neither one of the items “subcategories” or “constituent ingredients.”

Further, regarding the POI of ID 001, in the case that the referral text of the POI of ID 001 is created using the text “using turmeric powder made in ◯◯” for which the item of the referral information is classified as “constituent ingredients,” the referral text creation unit 32 creates the referral text of the POI of ID 002 using the referral information of at least one of the items of “subcategories” and “interior information,” which are items other than “constituent ingredients.”

Concerning the extracted POI (ID 002), instead of the manner described above, the referral text creation unit 32 may create the referral text in the following manner.

More specifically, in the case that the determination result, which indicates whether the item of the referral information used for the POI (ID 001) of the higher recommended priority is a specific item, is a predetermined result, the referral text creation unit 32 creates the referral text of the target POI (the POI of the lower recommended priority), using the referral information of an item that differs from the item of the referral information used for the POI (ID 001) of the higher recommended priority.

For example, in the case that the determination result, which indicates whether the item of the referral information used for the POI (ID 001) of the higher recommended priority is a “specific item,” such as “an item of referral information that has been set (or restricted) in advance by the user to allow usage thereof for a plurality of POI” or “an item of referral information that has been set (or restricted) in advance by the user profile information recording unit (user-specific preferences recording unit) 56 to allow usage thereof for a plurality of POI based on the orientation (preferences) of the user,” is YES (or alternatively, in the case of being NO), the referral text creation unit 32 may create the referral text of the POI (ID 002) of the lower recommended priority using the referral information of the same item as the item of the referral information used for the POI (ID 001) of the higher recommended priority, while on the other hand, in the case that the aforementioned determination result is NO (or alternatively, in the case of being YES), the referral text creation unit 32 may create the referral text of the POI (ID 002) of the lower recommended priority using the referral information of the item that differs from the item of the referral information used for the POI (ID 001) of the higher recommended priority.

In this case, from the addresses within the identification information of the extracted POI and the current position of the vehicle 16, voice output data, for example, of the text “a famous Indian curry restaurant is located ◯◯ km up ahead along the road,” and the text “a restaurant with private rooms available is located ◯◯ km up ahead along the road” and the like are created.

Next, in step S7, data of the information (image information and voice information), which includes the referral text created by the referral text creation unit 32, is transmitted to the output device 24 and the display device 26 via the communication unit 60, the network 14, and the communication unit 22.

Consequently, in step S7, the positions of the famous Indian curry restaurant and the famous Thai green curry restaurant are displayed on the map of the display device 26 of the vehicle 16, together with audio based on voice output data being output from the output device 24.

In step S8, the referral text creation unit 32, which has detected an OK input from the user Z who selects any of the POI (step S8: YES), uses the navigation unit 40, whereby in step S9, route guidance to the extracted POI (selected POI) is carried out.

Further, in step S8, in the case that an input of NG information (information indicating that referral POI are not selected) from the user Z such as a question “is there any other location?” is detected, then in step S4, the POI extraction unit 34 extracts the ID of the POI from the POI information recording unit 52 (for example ID 006) under conditions that differ from the previous ones (for example, the distance from the current location of the user is a predetermined distance Y (>X) km). In addition, the referral text creation unit 32 creates the referral text in step S6.

In this case, in step S7, the position of a “famous chicken curry restaurant” is displayed as a POI on the map of the display device 26, together with an output being provided from the output device 24 including the statement “a famous restaurant serving chicken curry using carrots grown in ◯◯ and local chicken raised in ◯◯ is located ◯◯ km up ahead along the road.”

Moreover, in step S8, in the case that an input of NG information (information indicating that referral POI are not selected) from the user such as a question “is there any other location?” is detected, and further, in the case that, from among the POI extracted in the aforementioned step S4, there are POI that have not been output together with the referral text from the output device 24 or the display device 26, the referral text creation and outputting processes in the aforementioned step S6 and step S7 may be carried out for the POI that have not been output.

### Inventions that can be Grasped from the Embodiment

A description will be given below concerning the inventions capable of being grasped from the above-described embodiment. Although in order to facilitate understanding, the reference numerals used in the embodiment are applied to the constituent elements, the constituent elements are not limited to those to which such reference numerals have been applied.

The information providing system (server 10) according to the present invention is characterized by the information providing system (server 10) comprising the points of interest (POI) information recording unit 52 in which the identification information of POI is recorded in association with the referral information of the POI, and the referral text creation unit 32 which creates the referral text concerning the POI by using the referral information associated with the POI, the information providing system further comprising the POI extraction unit 34 that extracts, based on the input from a user Z, a plurality of the POI to be output to the user Z, from the POI information recording unit 52 together with a recommended priority, wherein the POI information recording unit 52 records the referral information of the POI together with an item, and the referral text creation unit 32 creates the referral text of the first POI extracted by the POI extraction unit 34, by using the referral information associated with the first POI, and creates the referral text of the second POI extracted with the recommended priority lower than the recommended priority of the first POI, by using, from among pieces of the referral information associated with the second POI, the referral information of an item that differs from the item of the referral information used for the referral text of the first POI.

According to the above configuration, when the referral text of the plurality of POI is created based on the input from the user Z, the referral text of the first POI extracted by the POI extraction unit 34 based on the input from the user Z is created using the referral information associated with the first POI, and the referral text of the second POI extracted with a recommended priority lower than that of the first POI is created using, from among pieces of the referral information associated with the second POI, the referral information of an item that differs from the item of the referral information used for the referral text of the first POI.

Therefore, the referral text of the plurality of POI can be made in a diverse manner, and it is possible to increase the possibility that POI preferred by the user Z based on the input from the user Z can be quickly determined at one time. As a result, it is possible to provide, to the user Z, the referral text created by taking into consideration the recommended priority, for the user Z, of the plurality of POI to be introduced to the user Z.

In this case, in the case that a determination result, which indicates whether or not the item of the referral information associated with the first POI used for creation of the referral text of the first POI is a specific item, is a predetermined result, the referral text creation unit 32 may create the referral text of the second POI by using, from among the pieces of the referral information associated with the second POI, the referral information of the item that differs from the item of the referral information used for the referral text of the first POI.

The present invention is not limited to the embodiment described above, and it is a matter of course that various modified or additional configurations could be adopted therein based on the disclosed content of the present specification.

For example, in the above-described embodiment, the information providing system is provided in the form of the server 10; however, the information providing system may also be provided in the form of the vehicle 16, by the vehicle 16 being allowed to possess the computation unit 30 and the recording unit 50 shown in FIG. 1. The information providing system may be constituted by the server 10 and the vehicle 16. The vehicle 16 may be a passenger vehicle such as a four-wheeled vehicle, a truck, a two-wheeled vehicle, or the like. Further, the information providing system may be a mobile terminal such as a smartphone that is carried by the user.

What is claimed is:

1. An information providing system comprising a points of interest (POI) information recording unit configured to record identification information of POI in association with referral information of the POI, and a referral text creation unit configured to create referral text concerning the POI by using the referral information associated with the POI, the information providing system further comprising
a POI extraction unit configured to extract, based on an input from a user, a plurality of the POI to be output to the user, from the POI information recording unit together with a recommended priority,
wherein the POI information recording unit records the referral information of the POI together with an item, and
the referral text creation unit creates referral text of first POI extracted by the POI extraction unit, by using the referral information associated with the first POI, and creates referral text of second POI extracted with the recommended priority lower than the recommended priority of the first POI, by using, from among pieces of the referral information associated with the second POI, the referral information of an item that differs from an item of the referral information used for the referral text of the first POI.

2. The information providing system according to claim 1, wherein, in a case that a determination result, which indicates whether or not the item of the referral information associated with the first POI used for creation of the referral text of the first POI is a specific item, is a predetermined result, the referral text creation unit creates the referral text of the second POI by using, from among the pieces of the referral information associated with the second POI, the referral information of the item that differs from the item of the referral information used for the referral text of the first POI.
